(19) United States
(12) Patent Application Publication
(10) Pub. No.: US 2020/0167169 A1
(43) Pub. Date: May 28, 2020

(54) METHOD FOR RESETTING A MANAGEMENT HARDWARE COMPONENT OF A COMPUTER SYSTEM AND A COMPUTER SYSTEM OF THIS KIND

(71) Applicant: FUJITSU LIMITED, Kawasaki-shi, (JP)

(72) Inventors: Martin CLEMENS, München (DE); Franz SCHLOSSER, München (DE)

(73) Assignee: FUJITSU LIMITED, Kawasaki-shi (JP)

(21) Appl. No.: 16/687,939

(22) Filed: Nov. 19, 2019

(30) Foreign Application Priority Data
Nov. 27, 2018 (DE) 102018129982.6

(51) Int. Cl. G06F 9/445; G06F 9/4401; G06F 1/24

(52) U.S. Cl. CPC G06F 9/445; G06F 9/4418; G06F 1/24; G06F 9/4411; G06F 9/4403

(57) ABSTRACT

The invention relates to a method for resetting a management hardware component of a computer system. A request for resetting the management hardware component is received via a running host operating system of the computer system and a reset signal is generated. The reset signal causes the management hardware component to be reset. Also described is a computer system which comprises a host operating system and such management hardware component and is adapted to perform such a method.

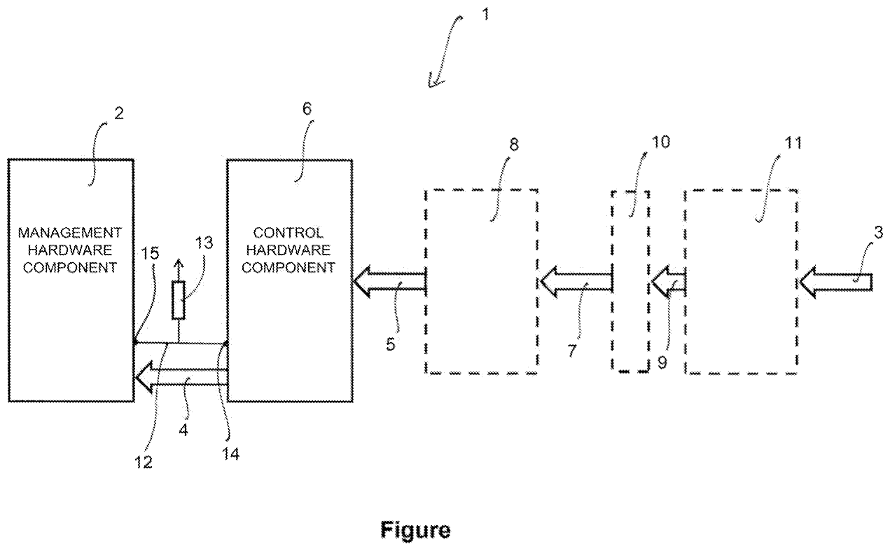

### TECHNICAL FIELD

The invention relates to a method for resetting a management hardware component of a computer system. In addition, the invention relates to computer system including a host operating system and a management hardware component.

### BACKGROUND

In computer systems, e.g at servers, often management hardware components are used for managing the components of the computer system and for detecting and monitoring system parameters of such kind of components. Such a management hardware component may for example include a so-called Baseboard Management Controller (BMC).

Management hardware components are usually configured as complex controllers having a dedicated processor or system kernel and a separate firmware. Thus management hardware components may be prone to error and fail, whereby the management hardware components may not be addressed by other components of the computer systems or by external or remote systems anymore. In said case, a system management of the computer system may no longer be possible. Thus, a reset of the management hardware component is required to terminate the failure and to restart the management hardware components.

Conventional solutions provide a hardware watchdog circuit within the management hardware component which automatically resets the management hardware component, for example, in case the management hardware component will not periodically restart the watchdog circuit by means of the firmware thereof. Said solution enables a resetting of the management hardware component in case of a firmware failure, however, is not able to handle a case, where an interface of the management hardware component has an external failure, but the firmware of the management hardware component continues to work, for example. As it may not be detected by the described watchdog circuit.

Alternative conventional solutions provide a push button at the computer system by means of which a resetting of the management hardware component may be enforced (hardware or software controlled). Such kind of solutions have the drawback that a technician or administrator has to trigger the reset directly at the computer system (the respective person has to be present).

In addition to the solutions mentioned above, the patent document U.S. Pat. No. 9,891,678 B2 describes a system for resetting a management controller by means of the so-called power over ethernet technology (PoE). Hereby, a PoE detection circuit detects predetermined switching thresholds or voltage thresholds of the PoE interface, and triggers the reset of the management controller. The solution has the disadvantage that additional hardware has to be integrated within the computer system in order to implement this kind of reset mechanism. This results in increased system costs for the computer system.

It is an object of the present invention to describe a method and a computer system of the kind described above which enable a reset of the management hardware component of the computer system in an easy but also feasible way.

### SUMMARY

According to a first aspect, this object is achieved by a method according to claim 1. Advantageous implementations are disclosed in the dependent claims.

The method is implemented in order to reset a management hardware component of a computer system, wherein a request to reset the management hardware component is received by means of a running host operating system of the computer system and a reset signal is generated which causes a reset of the management hardware component.

Such a method enables a reset of the management hardware component which is controlled by the operating system in a simple way. By means of the running host operating system of the computer system, a request for resetting the management hardware component is implemented in a reset signal. The reset signal causes the reset of the management hardware component.

Such a method has the advantage that a dedicated hardware or any dedicated hardware modifications for resetting the management hardware component have not to be prepared or may only be prepared to the small extent. A control of resetting is performed by means of the running host operating system of the computer system (so-called In-Band control). The request for resetting is processed by the running host operating system of the computer system and, controlled by the host operating system, a reset of the management hardware component is triggered. This way, the method may be implemented in a very easy way, yet providing a convenient range of features.

The term “host operating system” describes the primary operating system of the computer system by means of which any components of the computer systems are controlled and which represents the basic operating system for running applications or utility programs of the computer system. For example, the host operating system is different from the firmware or the control software which are implemented in individual components of the computer system, for example in the management hardware component, for the execution control thereof. Rather, the host operating system is the master operating system of the computer system for master control of the computer system at software level.

In various implementations of the method, the request for resetting the management hardware component is triggered by a remote system and received by the computer system via the network. This way, a reset of the management hardware component may be conveniently triggered by a remote system, for example by an administrator without having to work locally at the computer system. The request for resetting the management hardware component may be received by the computer system via a LAN network (local area network), for example.

In various implementations of the method, a control command is generated and a control hardware component of the computer system is controlled by means of the control command. The control hardware component may generate the reset signal. In said implementations, the request for resetting the management hardware component may thus be implemented in the control command. By means of the control command, a control hardware component which is separate from the management hardware component of the computer system is controlled. The control hardware component may generate the reset signal by itself, and control the management hardware component in a way that the reset of the management hardware component is triggered.

The control hardware component is configured to control components of the computer system, e.g. hardware components, add-on components, peripheral components, etc. Preferably, the control hardware component is also configured for communication with the processor of the computer system. This way, the processor of the computer system may communicate with the control hardware component, wherein the latter is in turn communicating with the management hardware component for resetting it. Thus, the method may use traditional processing communication and processes within the computer system without having to implement expensive additional communication, e.g. between the processor and the management hardware component itself. This also contributes to a simple and cost efficient implementation of the method. The control component is for example a so-called Platform Controller Hub (PCH).

In various implementations of said method a trigger command is generated, wherein the trigger command triggers the execution of control program code for generating the reset signal. Thus, by means of the control program code, the generation of the reset signal may be controlled at software level in a targeted way. The control program code itself is triggered or executed when the trigger command hereto is generated. The functionality of the control program code has the advantage that the reset of the management hardware components in the way described above may be easily integrated at software level in an existing software architecture, without having to change or adapt the software architecture as a whole in a fundamental way (apart from respective interfaces). By means of the control program code a functionality of the host operating system of the computer system becomes independent—apart from triggering the method—from the implementation of the method. For example, the control program code may be implemented independently of the host operating system within the computer system. Triggered by a request for resetting the management hardware component and the processing thereof by means of the host operating system, this way a trigger command may be generated which in turn triggers the execution of the control program code for generating the reset signal.

In various implementations of the method, the control command described above is generated by execution of control program code by means of which the control hardware component of the kind described above is controlled. This way, an implementation of the described preset functionality by means of the control program code at software level is performed (however, preferably separated from the host operating system) in a control command at the hardware level for controlling the control hardware component which respectively controls and resets the management hardware component.

In various implementations of the method, a driver command is generated, wherein the driver command controls a driver for generating the reset signal. The driver command may for example be generated by means of the host operating system or by means of the program running on the host operating system. Preferably, the driver acts as an interface between the host operating system and any subsequent process execution at software or hardware level for resetting the management hardware component. For example, the driver is used to implement operating system specific commands or instructions in command or instructions which are separated therefrom.

In various implementations of the method, the driver generates the trigger command described above, which in turn triggers the execution of the control program code described. The trigger command may for example be an interrupt command which is generated by the driver for the processor of the computer system. When receiving an interrupt command by the processor, the processing or execution of the control program code in the processor is triggered. By executing the control program code, the control command for controlling the control hardware component is generated. The control hardware component then generates the reset signal, and triggers a reset of the management hardware component.

In various implementations of the method, a running utility program is implemented in the host operating system. The running utility program processes the request for resetting the management hardware component and generates the driver command of the kind described above. The running utility program is for example a so-called “Daemon”, which responds to predetermined information regarding a request for resetting the management hardware component. In case of a local request, that is a request which is locally triggered by the computer system, the utility program locally responds to said request. In case of a remote request, that is a request which has been triggered by a remote system and is received by the computer system via a network (via a network interface setup hereto), the utility program processes the received request which has been remotely triggered. In said case, the utility program may for example be configured to register predefined network protocol commands or respective network signals which refer to or signal a reset request. Said information may be further processed by means of the running utility program and the respective driver command may be generated. In alternative implementations, a further utility program may also be configured which receives respective commands from a first utility program, wherein the described driver command is generated by the second utility program. Here different implementations are possible.

A request for resetting the management hardware component (locally or by a remote system) may be secured by authentication or authorization methods, for example by so-called credentials, certificates, port knocking or other safety mechanisms. Said safety mechanisms may be implemented within the running utility program(s) or within the host operating system. This may prevent that unauthorized systems or users cause a reset of the management hardware component or manipulate the process in any other way.

According to a second aspect, the above object is achieved by a method according to claim 9. Specific embodiments are disclosed in the dependent claims.

The computer system is configured with a host operating system and a management hardware component. The management hardware component is a BMC, for example. Further, the computer system is configured to receive a request for resetting the management hardware component by means of the running host operating system and to generate a reset signal which causes the reset of the management hardware component.

By means of such a computer system, the advantages which have been described above relating to a respective method may also be achieved. In addition, the computer system thus enables a software controlled reset of the management hardware component. Such a software control is easy to implement. In such a computer system, required adaptions and modifications of the hardware may be reduced to a minimum.

In various embodiments, the computer system comprises a network interface for receiving the request for resetting the management hardware component from a remote system over a network. This way, the computer system is configured to receive remote requests for resetting the management hardware component.

In various embodiments, in addition to the management hardware component, the computer system comprises a control hardware component. A control output of the control hardware component is connected to the reset input of the management hardware component via the signal line. The control hardware component is configured to generate the reset signal. In said embodiments, the control hardware component which is separate from the management hardware component is used for resetting the management hardware component. The control hardware component may be a component which is conventionally set up in the computer system for controlling any hardware components, peripheral components, add-on components etc. The control hardware component is for example a PCH. The control hardware component is connected to the management hardware components via a signal line. By means of said signal line, the reset signal from a control output of the control hardware component may be applied to a reset input of the management hardware component. No further dedicated hardware implementations are required.

In various embodiments of the computer system, a driver is configured to generate a trigger command to trigger an execution of control program code for generating the reset signal. Hereby the advantage of processing the described functionality (apart from triggering the reset functionality) independently from the host operating system, which has been described regarding the method above, is achieved. Moreover, reference is made to the advantages which have been described above in relation to the described method.

In various embodiments of the computer system, a utility program (Daemon) is implemented in the host operating system to process a request for resetting the management hardware component and to generate a driver command for controlling the driver. Regarding said embodiments, the advantages stated for the methods described above are achieved, to which reference is made here.

In various embodiments of the computer system, the control program code is implemented to generate by its execution a control command for controlling the control hardware component, as described above. Thus the computer system is configured to implement a request for resetting the management hardware component by the control program code at the software level in a control at hardware level. At the hardware level, a reset of the management hardware component is performed by the control hardware component in a controlled way. Moreover, reference is made here to the specifications relating to the method described above.

Any advantageous aspects, implementations and features of the methods described above may be used in the respective designs, implementations, aspects, and features of the computer system described and vice versa.

Preferably, the computer system of the kind described is configured to perform a method according to the kind described above.

### DETAILED DESCRIPTION

The invention is described in the following by means of an exemplary embodiment by using a FIGURE. The FIGURE shows an exemplary implementation of the computer system 1 including a management hardware component 2. The management hardware component 2 is for example a BMC. The computer system 1 may be a server or any other computer system.

In case of a failure of the management hardware component 2 any further operation may be interrupted, and it may not be fully functional. Hereby, a management of the components of the computer system 1 by means of the management hardware component 2 may no longer be performed. Thus, in such a failure, the management hardware component 2 has to be reset.

The computer system 1 is implemented in a way that an easy reset of the management hardware component 2 is possible. Hereto, the management hardware component 2 is connected to a control hardware component 6 via a signal line 12. More precisely, the control output 14 of the control hardware component 6 is connected to a reset input 15 of the management hardware component 2 via a signal line 12. Starting from a negative logic of the reset input 15, a pull-up resistor 13 is switched on the signal line 12 which keeps the signal line 12 at a predefined high electrical potential (logically HIGH), if the control hardware component 6 does not actively switch to a lower electric potential (logically LOW) via the control output 14 thereof, which will be described later in detail. This way, the management hardware component 2 and the control hardware component 6 are interconnected at hardware level.

The control hardware component 6 is configured to control the various components of the computer system 1, as for example the hardware components, add-on components, peripheral components etc. Hereto, the control hardware component 6 communicates with various hardware components and with a processor (not shown) of the computer system 1. The control hardware component 6 is for example a PCH.

In addition to a management hardware component 2 and the control hardware component 6, the computer system 1 comprises a variety of software components 8, 10, and 11. As opposed to the hardware components 2 and 6, these are shown in the FIGURE by dashed lines. This means, that in the FIGURE, the components 2 and 6 denote the used hardware components, while the dashed components 8, 10, and 11 denote the used software components.

The software components of the computer system 1 comprises a control program code 8, which is able to generate a control command 5 for the control hardware component 6 during run-time or execution thereof. The control program code 8 is for example an ASL-Code (ACPI source language, ACPI=advanced configuration and power interface). The control program code 8 is for example a code component of a BIOS code (basic input output system). The control program code 8 is specifically implemented for resetting the management hardware component 2, which is described here.

As a further software component, a driver 10 is implemented in the computer system 1, which may generate a trigger command 7 for triggering the control program code 8. The driver 10 is e.g. configured as interface between components of the host operating system of the computer system 1 and other software components of the computer system 1. The host operating system of the computer system 1 acts here as the master operating system for the basic control of the computer system 1. The driver 10 may be implemented within or in communication with the host operating system. The trigger command 7 is for example in interrupt command which triggers the execution of the control program code 8 within the processor of the computer system 1. The processor may here comprise one or more processor kernels.

As a further software component, a utility program 11 is set up. The utility program 11 is an example of a running service (daemon) or which is running within the host operating system of the computer system 1.

The utility program 11 monitors a network interface (not shown) of the computer system 14 for dedicated network signals or commands regarding a request 3 for resetting the management hardware component 2. The request 3 may here be sent from a remote system to the computer system 1 via a network, for example a LAN network. The request 3 is then detected and processed by the running utility program 11.

Then the utility program 11 or a subsequent utility program or the host operating system itself creates a driver command 9 by means of which the driver 10 is controlled. The driver 10 then generates the trigger command 7 which triggers the running or execution of the control program code 8. By executing the control program code 8, the control command 5 which controls the control hardware component 2 is generated. The control hardware component 6 then creates the reset signal 4 at the control output 14 thereof.

In this case, the reset signal 4 is a signal pulse having a low electrical potential which actively pulls the signal line 12 or the reset input 15 of the management hardware component 2 to the low potential (logically LOW). Said signal change at the signal line 12 causes a signal change (from logically HIGH) at the reset input 15 of the management hardware component 2 due to a pull-up resistor 14 (to logically LOW), such that the management hardware component 2 is actively controlled and reset. Within the management hardware component 2 dedicated control processes may be executed for this purpose, which may be controlled by an internal execution control. Then, the management hardware component 2 restarts and is completely operative again.

As described, the reset signal 4 is preferably a pulse signal. This has the advantage that the reset of the management hardware competent 2 is triggered by the pulse one time, wherein subsequently the signal line 12 is re-set to a higher potential (logically HIGH) by means of a pull-up resistor 13. This way, it is prevented that the management hardware component 2 is subjected to multiple resets which may be performed one after the other without any control.

The communication of the control command 5 to the control hardware component 6 may be performed by a communication line between the processor, which processes the control program code 8, and the control hardware component 6. Such a communication may for example be performed via a PCI bus (peripheral component interconnect) or DMI interface (desktop management interface).

The reset output 14 of the control hardware component 6 may for example be realized by a so-called GPIO pin (general-purpose input output). The reset input 15 of the management hardware component 2 is for example a dedicated reset pin for applying a reset signal.

The exemplary implementation shown in the FIGURE enables a simple reset of the management hardware component 2 by means of a software control, by which a request 3 for resetting the management hardware component 2 by means of various software communication and process steps is implemented in a control command 5, which again triggers a reset signal 4 for resetting the management hardware component 2. The process steps described are thus triggered by means of a running host operating system (In-Band) or by means of a running utility program 11 in the host operating system within the computer system 1 in response to a request 3.

In alternative embodiments and implementations, the control program code 8 may also be emitted. Thereby, the driver 10 is configured to generate various trigger commands 7, for example formed as various interrupt commands. This way, a processor controlled generation of different control components 5 may be generated, which again control the application of different signals to a signal line 12 in the control hardware component 6 for actively triggering a reset of the management hardware component 2 or a normal operation of the management hardware component 2 without reset.

The illustrated implementations and embodiments are merely chosen as examples.

1. A method for resetting a management hardware component of a computer system, the method comprising:
receiving, at a running host operating system, a request for resetting the management hardware component of the computer system; and
generating a reset signal which causes the management hardware component to be reset.

2. The method according to claim 1, wherein the request for resetting the management hardware component is initiated via a remote system and received by the computer system via a network.

3. The method according to claim 1, wherein a control command is generated and a control hardware component of the computer system is driven by the control command, the control hardware component in turn generating the reset signal.

4. The method according to claim 1, wherein a trigger command is generated and the trigger command triggers the execution of control program code for generating the reset signal.

5. The method according to claim 3, wherein the control command is generated by executing the control program code.

6. The method according to claim 4, wherein the control command is generated by executing the control program code.

7. The method according to claim 1, wherein a driver command is generated and the driver command controls a driver for generating the reset signal.

8. The method according to claim 4, wherein the driver generates the trigger command.

9. The method according to claim 7, wherein the driver generates the trigger command.

10. The method according to claim 7, wherein a utility program running in the host operating system processes the request for resetting the management hardware component and generates the driver command.

11. A computer system comprising:
a host operating system; and
a management hardware component,
wherein the computer system is configured to receive a request for resetting the management hardware component by the running host operating system and to generate a reset signal which causes the management hardware component to be reset.

12. The computer system according to claim 11, wherein the computer system comprises a network interface for receiving the request for resetting the management hardware component from a remote system over a network.

13. The computer system according to claim 11, wherein the computer system comprises a control hardware component, a control output of the control hardware component being connected via a signal line to a reset input of the management hardware component, and
wherein the control hardware component is configured to generate the reset signal.

14. The computer system according to claim 11, wherein a driver is configured to generate a trigger command in order to trigger an execution of a control program code for generating the reset signal.

15. The computer system according to claim 14, wherein a utility program is implemented in the host operating system to process the request for resetting the management hardware component and generate a driver command for driving the driver.

16. The computer system according to claim 13, wherein the control program code is implemented to generate by its execution a control command for controlling the control hardware component.

17. The computer system according to claim 14, wherein the control program code is implemented to generate by its execution a control command for controlling the control hardware component.
